(19) United States
(12) Patent Application Publication
(10) Pub. No.: US 2015/0088294 A1
(43) Pub. Date: Mar. 26, 2015

(54) ENVIRONMENTAL MONITORING SYSTEM AND METHOD FOR LIQUID CRYSTAL MANUFACTURING APPARATUS

(71) Applicant: Shenzhen China Star Optoelectronics Technology Co. Ltd., Shenzhen (CN)

(72) Inventors: Yunshao Jiang, Shenzhen (CN); Chun Hao Wu, Shenzhen (CN); Kun Hsien Lin, Shenzhen (CN); Yongqiang Wang, Shenzhen (CN); Zhiyou Shu, Shenzhen (CN); Minghu Qi, Shenzhen (CN); Xiande Li, Shenzhen (CN); Zhenhua Guo, Shenzhen (CN); Weibing Yang, Shenzhen (CN); Zenghong Chen, Shenzhen (CN)

(21) Appl. No.: 13/637,679

(22) PCT Filed: Jun. 7, 2012
(86) PCT No.: PCT/CN12/76569

§ 371 Date: Sep. 27, 2012

(30) Foreign Application Priority Data
Jun. 6, 2012 (CN) 201210184115.1

(51) Int. Cl. G05B 19/406

(52) U.S. Cl. CPC G05B 19/406; G05B 2219/32015; G05B 2219/37507
USPC 700/108

(57) ABSTRACT

The present invention provides an environmental monitoring system and method for a liquid crystal manufacturing apparatus. The monitoring system comprises an environmental information acquiring equipment, a server, and the liquid crystal manufacturing apparatus. The environmental information acquiring equipment moves along a predetermined track inside the liquid crystal manufacturing apparatus. The environmental information acquiring equipment acquires inner environmental information of the liquid crystal manufacturing apparatus during its movement and transmits the environmental information to the server. The server generates a monitoring report and provides it to detecting personnel. The present invention can solve the problems of high cost, low efficiency, and unable to accurately measure inner environmental information of the liquid crystal manufacturing apparatus in conventional skills.

### BACKGROUND OF THE INVENTION

1. Field of the Invention

The present invention relates to a liquid crystal display technology, and more particularly, to an environmental monitoring system and method for a liquid crystal manufacturing apparatus.

2. Description of Prior Art

As a liquid crystal manufacturing technology is developing steadily and liquid crystal displays are widely used, it makes great demands on the manufacturing efficiency for the liquid crystal displays.

During manufacturing the liquid crystal displays such as thin-film-transistor liquid crystal displays (TFT-LCDs), the manufacturing environment is a significant factor to affect the quality and product yield of the TFT-LCDs. The workshop environment is mainly classified by dust or particle properties. When the dust is ranked with higher grade, the workshop environment has a lower degree of air purity. The classification of the dust or particles may comprise particle diameter, the number of particles per unit volume, and so on.

In conventional skills, TFT-LCD manufacturing environment is checked mainly by measuring instruments, which are controlled by workers. During the inspection, the workers can measure the particle degree of the workshop environment at a given time and place. Once the particle degree exceeds a certain set standard, the workers have to analyze the workshop environment and then provide corresponding treatment so as to make the particle degree of the workshop environment meet the standard.

However, the way the workers use the instrument to inspect the workshop environment as described above has following disadvantages:

(1) A real-time measurement for the particle degree of the workshop environment is not achieved. Once the particle degree of the workshop environment exceeds the standard, the workers cannot be informed in time. Therefore, the workers cannot instantly make some judgment and treatment for the workshop environment. This makes the efficiency reduced and it is easy to lead to adverse consequences.

(2) The particle degree of the inner environment of the liquid crystal manufacturing apparatus cannot be measured accurately. Therefore, the workers may not be able to clean the inner environment of the liquid crystal manufacturing apparatus right in time. This may reduce the product yield of the liquid crystal displays.

(3) Since it requires professional workers to operate specific machines for the inspection and it requires the professional workers to analyze the detection results and provide corresponding treatment, the cost is high and the efficiency is quite low.

### SUMMARY OF THE INVENTION

An object of the present invention is to provide an environmental monitoring method for a liquid crystal manufacturing apparatus for solving the problems of high cost, low efficiency, and unable to accurately measure inner environmental information of the liquid crystal manufacturing apparatus in conventional methods for inspecting the workshop environment.

To solve the above problems, the present invention provides an environmental monitoring method for a liquid crystal manufacturing apparatus, comprising steps of:

providing an environmental information acquiring equipment, a server, and the liquid crystal manufacturing apparatus used to produce liquid crystal panels;

controlling the environmental information acquiring equipment move along a predetermined track inside the liquid crystal manufacturing apparatus, and acquiring inner environmental information of the liquid crystal manufacturing apparatus by using the environmental information acquiring equipment during its movement, wherein the environmental information comprises a number of particles per unit volume in the liquid crystal manufacturing apparatus;

the environmental information acquiring equipment transmits the acquired environmental information to the server by wireless communication; and

the server receives the environmental information, generates an environmental monitoring report according to the received environmental information, and provides the environmental monitoring report to detecting personnel.

In the environmental monitoring method of the present invention, the liquid crystal manufacturing apparatus comprises a cassette, and the step of controlling the environmental information acquiring equipment move along the predetermined track inside the liquid crystal manufacturing apparatus comprises:

providing a master control system; and

arranging the environmental information acquiring equipment on the cassette of the liquid crystal manufacturing apparatus, and utilizing the master control system to control the environmental information acquiring equipment move along the predetermined track inside the liquid crystal manufacturing apparatus.

In the environmental monitoring method of the present invention, the predetermined track is a track of a glass substrate used to form the liquid crystal panel during a process of manufacturing the liquid crystal panel by using the liquid crystal manufacturing apparatus.

In the environmental monitoring method of the present invention, the environmental information further comprises diameters of particles located inside the liquid crystal manufacturing apparatus.

In the environmental monitoring method of the present invention, the environmental monitoring report comprises an environmental abnormality list, and the environmental abnormality list is generated by the server, according to predetermined environmental abnormality judgment conditions set in the server.

In the environmental monitoring method of the present invention, the environmental monitoring report comprises an environmental improvement list, and the environmental improvement list is generated by the server, according to the environmental abnormality list and a predetermined environmental improving standard set in the server.

In the environmental monitoring method of the present invention, the step of providing the environmental monitoring report to the detecting personnel comprises:

the server providing the environmental monitoring report to the detecting personnel by e-mail.

Another object of the present invention is to provide an environmental monitoring method for a liquid crystal manufacturing apparatus for solving the problems of high cost, low efficiency, and unable to accurately measure inner environmental information of the liquid crystal manufacturing apparatus in conventional methods for inspecting the workshop environment.

To solve the above problems, the present invention provides an environmental monitoring method for a liquid crystal manufacturing apparatus, comprising steps of:

providing an environmental information acquiring equipment, a server, and the liquid crystal manufacturing apparatus used to produce liquid crystal panels;

controlling the environmental information acquiring equipment move along a predetermined track inside the liquid crystal manufacturing apparatus, and acquiring inner environmental information of the liquid crystal manufacturing apparatus by using the environmental information acquiring equipment during its movement;

transmitting the acquired environmental information to the server; and the server receives the environmental information, generates an environmental monitoring report according to the received environmental information, and provides the environmental monitoring report to detecting personnel.

In the environmental monitoring method of the present invention, the liquid crystal manufacturing apparatus comprises a cassette, and the step of controlling the environmental information acquiring equipment move along the predetermined track inside the liquid crystal manufacturing apparatus comprises:

providing a master control system; and

arranging the environmental information acquiring equipment on the cassette of the liquid crystal manufacturing apparatus, and utilizing the master control system to control the environmental information acquiring equipment move along the predetermined track inside the liquid crystal manufacturing apparatus.

In the environmental monitoring method of the present invention, the predetermined track is a track of a glass substrate used to form the liquid crystal panel during a process of manufacturing the liquid crystal panel by using the liquid crystal manufacturing apparatus.

In the environmental monitoring method of the present invention, the environmental information acquiring equipment transmits the environmental information to the server by wireless communication after acquiring the environmental information inside the liquid crystal manufacturing apparatus.

In the environmental monitoring method of the present invention, the environmental information comprises a number of particles per unit volume and diameters of particles located inside the liquid crystal manufacturing apparatus.

In the environmental monitoring method of the present invention, the environmental monitoring report comprises an environmental abnormality list, and the environmental abnormality list is generated by the server, according to predetermined environmental abnormality judgment conditions set in the server.

In the environmental monitoring method of the present invention, the environmental monitoring report comprises an environmental improvement list, and the environmental improvement list is generated by the server, according to the environmental abnormality list and a predetermined environmental improving standard set in the server.

In the environmental monitoring method of the present invention, the step of providing the environmental monitoring report to the detecting personnel comprises:

the server providing the environmental monitoring report to the detecting personnel by e-mail.

Another object of the present invention is to provide an environmental monitoring system for a liquid crystal manufacturing apparatus for solving the problems of high cost, low efficiency, and unable to accurately measure inner environmental information of the liquid crystal manufacturing apparatus in conventional skills for inspecting the workshop environment.

To solve the above problems, the present invention provides an environmental monitoring system for a liquid crystal manufacturing apparatus, said monitoring system comprising a master control system, an environmental information acquiring equipment, and a server, wherein:

the master control system is connected to the environmental information acquiring equipment and is utilized to control the environmental information acquiring equipment move along a predetermined track inside the liquid crystal manufacturing apparatus;

the environmental information acquiring equipment is utilized to acquire inner environmental information of the liquid crystal manufacturing apparatus during its movement and transmit the acquired environmental information to the server; and

the server is utilized to receive the environmental information transmitted by the environmental information acquiring equipment, and process the received environmental information to generate an environmental monitoring report for detecting personnel.

In the environmental monitoring system of the present invention, said monitoring system further comprises a wireless signal transmitter, a wireless signal receiver, and a hub;

the wireless signal transmitter is utilized to transmit the environmental information acquired by the environmental information acquiring equipment to the wireless signal receiver by wireless communication;

the wireless signal receiver is utilized to transmit the environmental information to the hub; and

the hub is utilized to upload the environmental information to the server.

In the present invention, the environmental information acquiring equipment is arranged on the cassette. The master control system controls the environmental information acquiring equipment move in the liquid crystal manufacturing apparatus. The environmental information acquiring equipment can obtain the environmental information inside the liquid crystal manufacturing apparatus during its movement and transmit the obtained environmental information to the server by wireless communication. The server generates the environmental monitoring report according to the received environmental information. Therefore, the present invention can improve the monitoring efficiency and accuracy for the inner environment of the liquid crystal manufacturing apparatus. The operation procedure is simple and the cost is much low.

To make above content of the present invention more easily understood, it will be described in details by using preferred embodiments in conjunction with the appending drawings.

### BRIEF DESCRIPTION OF THE DRAWINGS

FIG. 1 is a structural diagram showing an environmental monitoring system for a liquid crystal manufacturing apparatus according to a preferred embodiment of the present invention.

FIG. 2 is a schematic diagram showing an environmental abnormality list in a form of Excel table according to the present invention.

FIG. 3 is a flow chart of an environmental monitoring method for a liquid crystal manufacturing apparatus according to a preferred embodiment of the present invention.

### DETAILED DESCRIPTION OF THE PREFERRED EMBODIMENTS

The following descriptions for the respective embodiments are specific embodiments capable of being implemented for illustrations of the present invention with referring to appended figures.

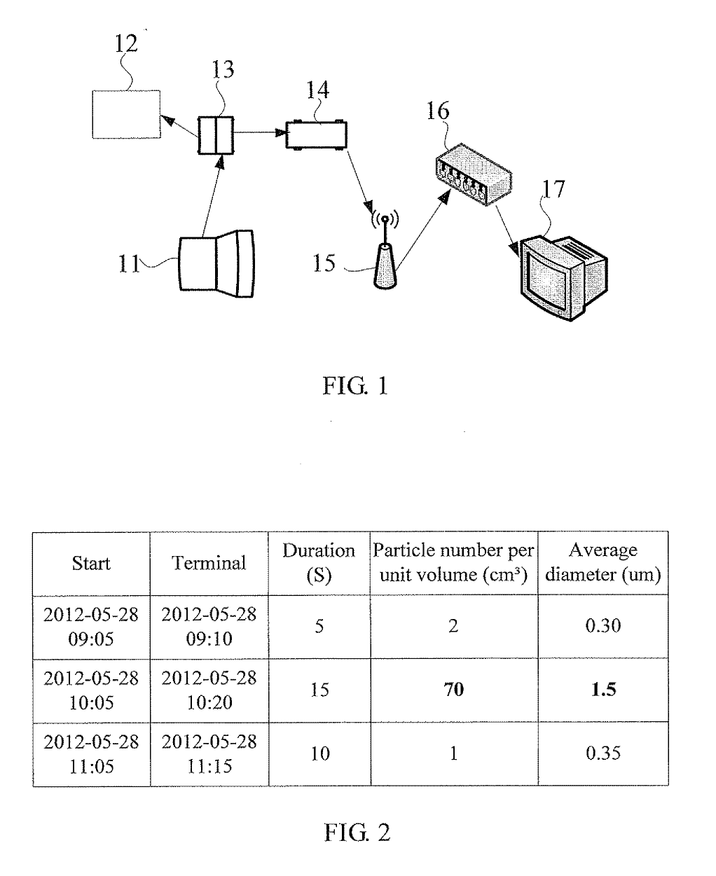

Refer to FIG. 1, which is a structural diagram showing an environmental monitoring system for a liquid crystal manufacturing apparatus according to the present invention.

The monitoring system comprises a master control system 11, a liquid crystal manufacturing apparatus 12, an environmental information acquiring equipment 13, a wireless signal transmitter 14, a wireless signal receiver 15, a hub 16, and a server 17.

The liquid crystal manufacturing apparatus 12 is utilized to produce liquid crystal panels. For example, a glass substrate is sputtered and coated with specific materials to form a metal layer, a gate insulating layer, and a semiconductor layer so as to form a TFT substrate. After that, another glass substrate is sputtered and coated with other specific materials to form a BM layer and color resists so as to form a color filter (CF) substrate. The TFT substrate and the CF substrate are necessary components of the liquid crystal panel. Off course, the liquid crystal panel further comprises a backlight module, which will not be detailedly described here.

The liquid crystal manufacturing apparatus 12 comprises a cassette (not labeled). During the process of producing the liquid crystal panel by using the liquid crystal manufacturing apparatus 12, the glass substrate used to form the TFT substrate, for example, is fastened on the cassette. With the movement of the cassette, the glass substrate moves along a predetermined track inside the liquid crystal manufacturing apparatus. The glass substrate is sputtered and coated to form the respective films during its movement. More specifically, the cassette causes the glass substrate to move along the predetermined track under the control of the master control system 11.

In the environmental monitoring system for the liquid crystal manufacturing apparatus according to the present invention, the environmental information acquiring equipment 13 is arranged on the cassette of the liquid crystal manufacturing apparatus 12. The master control system 11 controls the cassette move along the predetermined track such that the movement of the cassette cause the environmental information acquiring equipment 13 to move along the predetermined track inside the liquid crystal manufacturing apparatus 12. It is easy to see, from the above descriptions, that the route of the environmental information acquiring equipment 13 inside the liquid crystal manufacturing apparatus 12 is identical to that of the glass substrate during the liquid crystal manufacturing apparatus 12 produces the liquid crystal panel.

In other concrete implementations, after the environmental information acquiring equipment 13 is disposed on the cassette of the liquid crystal manufacturing apparatus 12, the master control system 11 also can control the cassette move along another track as long as the master control system 11 is able to control the environmental information acquiring equipment 13 acquire inner environmental information of the liquid crystal manufacturing apparatus 12, and thus this will be not detailedly described here.

During the process the environmental information acquiring equipment 13 moves inside the liquid crystal manufacturing apparatus 12, the environmental information acquiring equipment 13 acquires the inner environmental information of the liquid crystal manufacturing apparatus 12. For example, the environmental information comprises the number of particles per unit volume, particle diameter, and so on.

In addition, the environmental information acquiring apparatus 13 also may acquire the environmental information according to a predetermined period, for example, acquiring the environmental information one time for every one minute.

After the environmental information inside the liquid crystal manufacturing apparatus 12 is acquired, the environmental information acquiring equipment 13 transmits the acquired environmental information by wireless communication by using the wireless signal transmitter 14. In one embodiment, the environmental information acquiring equipment 13 may have a wireless component such as an infrared emitter disposed therein for the wireless communication. The details need not be given here.

The wireless signal transmitter 14 transmits the environmental information to the wireless signal receiver 15 by wireless communication. The wireless signal receiver 15 uploads the environmental information to the hub 16 and the hub 16 uploads the environmental information to the server 17.

The wireless communication between the wireless signal transmitter 14 and the wireless signal receiver 15 is preferable to be a WiFi network. It is definite that other types of wireless communication such as Bluetooth and infrared ray can be implemented as well. The wireless signal receiver 15 can be a router for wireless signals. Also, the wireless signal receiver 15 may transmit the environmental information to the hub 16 by line communication.

The server 17 processes the environmental information after the environmental information is obtained. The database of the server 17 stores some predetermined environmental abnormality judgment conditions and a predetermined environmental improving standard. After receiving the environmental information, the server 17 not only provides the environmental information to detecting personnel according to a normal process flow, but also determines the environmental information according to the predetermined environmental abnormality judgment conditions. If the particle number per unit volume or the particle diameter of the environmental information exceeds the environmental abnormality judgment conditions, an environmental abnormality list will be generated. The environmental abnormality list can be identified by specific colors. For example, it is assumed that the environmental abnormality judgment conditions are 10 particles per unit volume and 0.8 μm for particle diameter. When the environmental information records that the particle number is 70 per unit volume and the particle diameter is 1.5 μm, this exceeds the norm and the environmental abnormality list will be generated. Referring to a table shown in FIG. 2, abnormal environmental information is identified in bold type. Nevertheless, it also can be identified in red color. In concrete implementations, it also can express the abnormal environmental list by a chart having some curves, and this will not be detailed here.

In addition, when the particle number per unit volume or the particle diameter of the environmental information exceeds the environmental abnormality judgment conditions, the server 17 further generates an environmental improvement list according to a predetermined environmental improving standard for notifying a user to clean the inner space of the liquid crystal manufacturing apparatus 12. In the present embodiment, the environmental abnormality list and the environmental improvement list generated by the server 17 can be provided to the detecting personnel by email for providing a convenient way to the detecting personnel to acquire the environmental information in a manufacturing plant.

The server 17 also can provide a web server. The web server provides webpages that are constructed based on JAVA programs. Compared to a conventional particle monitoring software, the webpages constructed by JAVA programs can reduce cost. The web server may comprise a data query system, an alarm system, an improving system, and etc. The detecting personnel can access the web server of the server 17 and input related information such as a date for the inquiry so as to acquire the environmental information inside the liquid crystal manufacturing apparatus 12 in real time. Preferably, the server 17 may provide the environmental abnormality list and the environmental improvement list with Excel tables or charts according to user's desire.

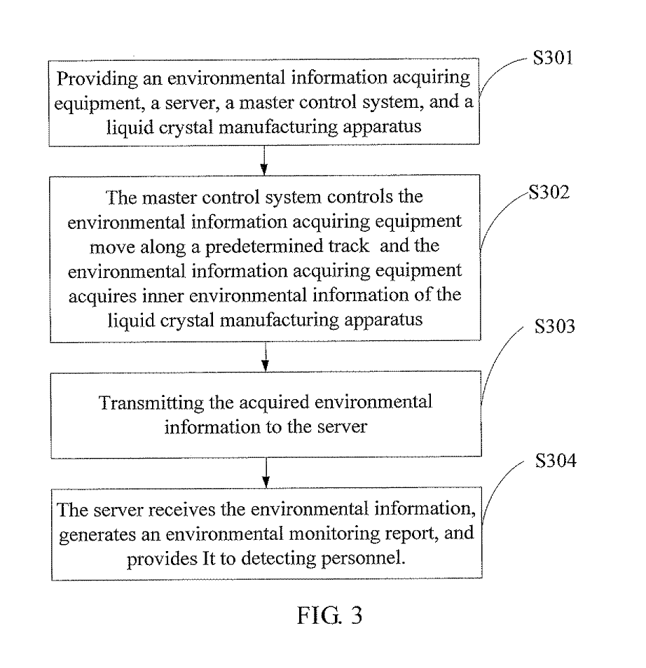

FIG. 3 is a flow char of an environmental monitoring method for a liquid crystal manufacturing apparatus according to the present invention.

In Step S301, provide an environmental information acquiring equipment 13, a server 17, a master control system 11, and a liquid crystal manufacturing apparatus 12.

The liquid crystal manufacturing apparatus 12 is utilized to produce liquid crystal panels. The liquid crystal manufacturing apparatus 12 comprises a cassette. During the manufacturing process, a glass substrate used to form the liquid crystal panel is arranged on the cassette and moves along a predetermined tract inside the liquid crystal manufacturing apparatus 12 under the control of the master control system 11.

In Step S302, the master control system 11 controls the environmental information acquiring equipment 13 move along the predetermined track inside the liquid crystal manufacturing apparatus 12, and the environmental information acquiring equipment 13 acquires inner environmental information of the liquid crystal manufacturing apparatus 12 during its movement.

In concrete implementations, the environmental information acquiring equipment 13 is disposed on the cassette which is located inside the liquid crystal manufacturing apparatus 12. The master control system 11 controls the cassette move along the predetermined tract inside the liquid crystal manufacturing apparatus 12. The predetermined track is a track of the glass substrate used to form the liquid crystal panel during the process of manufacturing the liquid crystal panel by using the liquid crystal manufacturing apparatus 12.

In the present invention, the environmental information comprises the number of particles per unit volume in the liquid crystal manufacturing apparatus 12 such as the number of particles in a cubic centimeter, and further comprises a particle diameter.

In Step S303, the acquired environmental information is transmitted to the server 17.

After acquiring the environmental information in the liquid crystal manufacturing apparatus 12, the environmental information acquiring equipment 13 transmits the acquired environmental information to the server 17 by wireless communication. The transmission approaches may be referred to the environmental monitoring system in the liquid crystal manufacturing apparatus as described above, and it is not repeated again here.

In Step S304, the server 17 receives the environmental information, generates an environmental monitoring report according to the received environmental information, and provides the environmental monitoring report to detecting personnel.

The environmental monitoring report comprises an environmental abnormality list and an environmental improvement list. The environmental abnormality list is generated by the server 17, according to predetermined environmental abnormality judgment conditions set in the server 17. The environmental improvement list is generated by the server 17, according to the environmental abnormality list and a predetermined environmental improving standard set in the server 17.

In the present invention, it is preferable for the server 17 to provide the environmental monitoring report to the detecting personnel by e-mail. It also can be provided to the detecting personnel by other approaches, for example, by webpages or short messages, and these will not be detailed here.

In the present invention, the environmental information acquiring equipment is arranged on the cassette. The master control system controls the environmental information acquiring equipment move in the liquid crystal manufacturing apparatus. The environmental information acquiring equipment can obtain the environmental information inside the liquid crystal manufacturing apparatus during its movement and transmit the obtained environmental information to the server by wireless communication. The server generates the environmental monitoring report according to the received environmental information. Therefore, the present invention can improve the monitoring efficiency and accuracy for the inner environment of the liquid crystal manufacturing apparatus. The operation procedure is simple and the cost is much low.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. An environmental monitoring method for a liquid crystal manufacturing apparatus, comprising steps of:
providing an environmental information acquiring equipment, a server, and the liquid crystal manufacturing apparatus used to produce liquid crystal panels;
controlling the environmental information acquiring equipment move along a predetermined track inside the liquid crystal manufacturing apparatus, and acquiring inner environmental information of the liquid crystal manufacturing apparatus by using the environmental information acquiring equipment during its movement, wherein the environmental information comprises a number of particles per unit volume in the liquid crystal manufacturing apparatus;
the environmental information acquiring equipment transmits the acquired environmental information to the server by wireless communication; and
the server receives the environmental information, generates an environmental monitoring report according to the received environmental information, and provides the environmental monitoring report to detecting personnel.

2. The environmental monitoring method according to claim 1, wherein the liquid crystal manufacturing apparatus comprises a cassette, and the step of controlling the environmental information acquiring equipment move along the predetermined track inside the liquid crystal manufacturing apparatus comprises:
providing a master control system; and
arranging the environmental information acquiring equipment on the cassette of the liquid crystal manufacturing apparatus, and utilizing the master control system to control the environmental information acquiring equipment move along the predetermined track inside the liquid crystal manufacturing apparatus.

3. The environmental monitoring method according to claim 2, wherein the predetermined track is a track of a glass substrate used to form the liquid crystal panel during a process of manufacturing the liquid crystal panel by using the liquid crystal manufacturing apparatus.

4. The environmental monitoring method according to claim 1, wherein the environmental information further comprises diameters of particles located inside the liquid crystal manufacturing apparatus.

5. The environmental monitoring method according to claim 1, wherein the environmental monitoring report comprises an environmental abnormality list, and the environmental abnormality list is generated by the server, according to predetermined environmental abnormality judgment conditions set in the server.

6. The environmental monitoring method according to claim 5, wherein the environmental monitoring report comprises an environmental improvement list, and the environmental improvement list is generated by the server, according to the environmental abnormality list and a predetermined environmental improving standard set in the server.

7. The environmental monitoring method according to claim 1, wherein the step of providing the environmental monitoring report to the detecting personnel comprises:
the server providing the environmental monitoring report to the detecting personnel by e-mail.

8. An environmental monitoring method for a liquid crystal manufacturing apparatus, comprising steps of:
providing an environmental information acquiring equipment, a server, and the liquid crystal manufacturing apparatus used to produce liquid crystal panels;
controlling the environmental information acquiring equipment move along a predetermined track inside the liquid crystal manufacturing apparatus, and acquiring inner environmental information of the liquid crystal manufacturing apparatus by using the environmental information acquiring equipment during its movement;
transmitting the acquired environmental information to the server; and
the server receives the environmental information, generates an environmental monitoring report according to the received environmental information, and provides the environmental monitoring report to detecting personnel.

9. The environmental monitoring method according to claim 8, wherein the liquid crystal manufacturing apparatus comprises a cassette, and the step of controlling the environmental information acquiring equipment move along the predetermined track inside the liquid crystal manufacturing apparatus comprises:
providing a master control system; and
arranging the environmental information acquiring equipment on the cassette of the liquid crystal manufacturing apparatus, and utilizing the master control system to control the environmental information acquiring equipment move along the predetermined track inside the liquid crystal manufacturing apparatus.

10. The environmental monitoring method according to claim 9, wherein the predetermined track is a track of a glass substrate used to form the liquid crystal panel during a process of manufacturing the liquid crystal panel by using the liquid crystal manufacturing apparatus.

11. The environmental monitoring method according to claim 8, wherein the environmental info cation acquiring equipment transmits the environmental information to the server by wireless communication after acquiring the environmental information inside the liquid crystal manufacturing apparatus.

12. The environmental monitoring method according to claim 8, wherein the environmental information comprises a number of particles per unit volume and diameters of particles located inside the liquid crystal manufacturing apparatus.

13. The environmental monitoring method according to claim 8, wherein the environmental monitoring report comprises an environmental abnormality list, and the environmental abnormality list is generated by the server, according to predetermined environmental abnormality judgment conditions set in the server.

14. The environmental monitoring method according to claim 13, wherein the environmental monitoring report comprises an environmental improvement list, and the environmental improvement list is generated by the server, according to the environmental abnormality list and a predetermined environmental improving standard set in the server.

15. The environmental monitoring method according to claim 8, wherein the step of providing the environmental monitoring report to the detecting personnel comprises:
the server providing the environmental monitoring report to the detecting personnel by e-mail.

16. An environmental monitoring system for a liquid crystal manufacturing apparatus, said monitoring system comprising a master control system, an environmental information acquiring equipment, and a server, wherein:
the master control system is connected to the environmental information acquiring equipment and is utilized to control the environmental information acquiring equipment move along a predetermined track inside the liquid crystal manufacturing apparatus;
the environmental information acquiring equipment is utilized to acquire inner environmental information of the liquid crystal manufacturing apparatus during its movement and transmit the acquired environmental information to the server; and
the server is utilized to receive the environmental information transmitted by the environmental information acquiring equipment, and process the received environmental information to generate an environmental monitoring report for detecting personnel.

17. The environmental monitoring system according to claim 16, wherein said monitoring system further comprises a wireless signal transmitter, a wireless signal receiver, and a hub;
the wireless signal transmitter is utilized to transmit the environmental information acquired by the environmental information acquiring equipment to the wireless signal receiver by wireless communication;
the wireless signal receiver is utilized to transmit the environmental information to the hub; and
the hub is utilized to upload the environmental information to the server.

18. The environmental monitoring system according to claim 16, wherein the predetermined track is a track of a glass substrate used to form the liquid crystal panel during a process of manufacturing the liquid crystal panel by using the liquid crystal manufacturing apparatus.

19. The environmental monitoring system according to claim 16, wherein the environmental information comprises diameters of particles located inside the liquid crystal manufacturing apparatus.
